(19) United States
(12) Patent Application Publication
(10) Pub. No.: US 2009/0258275 A1
(43) Pub. Date: Oct. 15, 2009

(54) POLYMER ELECTROLYTE, POLYMER ELECTROLYTE MEMBRANE, MEMBRANE ELECTRODE ASSEMBLY, AND FUEL CELL

(75) Inventors: Kyoko Kumagai, Toyota-shi (JP); Kenji Yamada, Yokohama-shi (JP); Kazuhiro Yamauchi, Suntou-gun (JP); Mamiko Kumagai, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/405,129

(22) Filed: Mar. 16, 2009

(30) Foreign Application Priority Data
Mar. 17, 2008 (JP) 2008-068441

(51) Int. Cl. H01M 8/10

(52) U.S. Cl. 429/33

(57) ABSTRACT

Provided is a polymer electrolyte including a triblock copolymer having: a segment A which has a glass transition temperature of 40° C. or lower, and is ion conductive; and a segment B which has a glass transition temperature of 70° C. or higher, and is non-ion conductive, the segment A and the segment B being connected in a sequence of B-A-B, wherein a weight fraction W_{A} of the segment A in the triblock copolymer is 0.05<W_{A}<0.5.

### BACKGROUND OF THE INVENTION

1. Field of the Invention

The present invention generally relates to a polymer electrolyte membrane which is excellent in high proton conductivity, mechanical strength, and shape/size stability against water, a polymer electrolyte which forms the polymer electrolyte membrane, a membrane electrode assembly and a fuel cell using the polymer electrolyte membrane.

2. Description of the Related Art

A method of utilizing a microphase separation formed by a block copolymer having an ion conductive segment and a non-ion conductive segment in its molecular structure is available for producing an electrolyte membrane for a polymer electrolyte fuel cell.

The polymer electrolyte membrane having a microphase separation structure has been attracting attention because an ion conductive domain can become an ion conducting channel, and thus ions can be transported thereby at relatively high efficiency. Electrolyte membranes having block copolymers including triblock and multiblock copolymers depending on a number of blocks to be used are known, as well as a diblock copolymer having two blocks.

An electrolyte membrane using a triblock copolymer has been disclosed in Japanese Patent Application Laid-Open No. 2006-312742. Here, it has been described that the electrolyte membrane having a phase separation structure and using a triblock copolymer consisting of a hydrophobic segment and an ion conductive segment having a sulfonic acid group exhibits higher ion conductivity than a random copolymer membrane.

Further, an electrolyte membrane using a triblock copolymer having hydrophobic segments at both ends of a hydrophilic segment has been disclosed as the electrolyte membrane for a lithium ion battery in Japanese Patent Application Laid-Open No. H02-500279. Here it has been described that the structure in which the hydrophobic domain is embedded in the hydrophilic domain may be easily formed in the phase separation structure because the hydrophilic segment is longer than the hydrophobic segment, and that a hydrophilic matrix having a low glass transition temperature contributes to flexibility of the entire membrane to impart suitable strength as the electrolyte membrane for the lithium ion battery.

However, in Japanese Patent Application Laid-Open No. 2006-312742, the glass transition temperature (Tg) may be high in both the hydrophilic segment and hydrophobic segment because the both segments have an aromatic main chain.

Therefore, it is conceivable that it may be difficult to control the phase separation structure and to assure an ion conductive channel with high efficiency.

In Japanese Patent Application Laid-Open No. H02-500279, the polymer electrolyte membrane has the microphase separation structure in which the hydrophobic domain is embedded in an ion conductive matrix having low Tg. Thus, it is conceivable that swelling of the matrix due to heat developed by cell driving and water generated by a cellular reaction may remarkably reduce the mechanical strength and the shape/size stability in the entire membrane when the electrolyte membrane is applied to the polymer electrolyte fuel cell (PEFC).

Accordingly, no electrolyte membrane is available which sufficiently provides excellent proton conductivity, mechanical strength of the membrane and shape/size stability against water for application to PEFC.

### SUMMARY OF THE INVENTION

A first aspect of the present invention provides a polymer electrolyte having a triblock copolymer including: a segment A which has a glass transition temperature of 40° C. or lower and is ion conductive; and a segment B which has a glass transition temperature of 70° C. or higher and is non-ion conductive, the segment A and the segment B being connected in a sequence of B-A-B, wherein a weight fraction W_{A} of the segment A in the triblock copolymer is 0.05<W_{A}<0.5.

Further, a second aspect of the present invention provides a polymer electrolyte membrane including a microphase separation structure including an ion conductive domain and a non-ion conductive domain, in which the microphase separation structure is formed of the polymer electrolyte according to the first aspect of the present invention.

A third aspect of the present invention provides a polymer electrolyte membrane including a triblock copolymer having: a segment A which has a glass transition temperature of 40° C. or lower and is ion conductive; and a segment B which has the glass transition temperature of 70° C. or higher and is non-ion conductive, the segment A and the segment B being connected in a sequence of B-A-B, wherein, in a microphase separation structure formed by the triblock copolymer, an ion conductive domain including the segment A forms a continuous phase and a non-ion conductive domain including the segment B forms a matrix phase.

Further, a fourth aspect of the present invention provides a membrane electrode assembly which includes electrodes placed on both sides of a polymer electrolyte membrane.

Further, a fifth aspect of the present invention provides a fuel cell including at least electrodes placed on both sides of the polymer electrolyte membrane and a current collector.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain principles of the invention.

FIG. 1 is a schematic view illustrating one example of a polymer electrolyte according to an embodiment of the present invention.

FIG. 2 is a schematic view illustrating one example of a microphase separation structure in a polymer electrolyte membrane according to an embodiment of the present invention.

FIG. 3 is a transmission electron microscope (TEM) photograph illustrating a lamellar microphase separation structure of the polymer electrolyte membrane in Example 1.

FIG. 4 is a transmission electron microscope (TEM) photograph illustrating the cylindrical microphase separation structure in Example 2.

FIG. 5 is a transmission electron microscope (TEM) photograph illustrating the lamellar microphase separation structure in Example 3.

FIG. 6 is a conceptual view illustrating one example of a membrane electrode assembly according to an embodiment of the present invention.

FIG. 7 is a conceptual view illustrating one example of a fuel cell according to an embodiment of the present invention.

FIG. 8 is a transmission electron microscope (TEM) photograph illustrating the cylindrical microphase separation structure in Example 4.

FIG. 9 is a graph illustrating the performance of a fuel cell in Example 6.

FIG. 10 is a graph illustrating the performance of a fuel cell in Comparative Example 3.

FIG. 11 is a transmission electron microscope (TEM) photograph illustrating the three-dimensional network microphase separation structure in Example 5.

### DESCRIPTION OF THE EMBODIMENTS

Embodiments of the present invention will be described in detail below.

A first aspect of the present invention provides a polymer electrolyte including a triblock copolymer, having a segment A which has a glass transition temperature of 40° C. or lower and is ion conductive, and a segment B which has a glass transition temperature of 70° C. or higher and is non-ion conductive, the segment A and the segment B being connected in a sequence of B-A-B, in which a weight fraction W_{A} of the segment A in the triblock copolymer is 0.05<W_{A}<0.5.

The first aspect of the present invention will be described below.

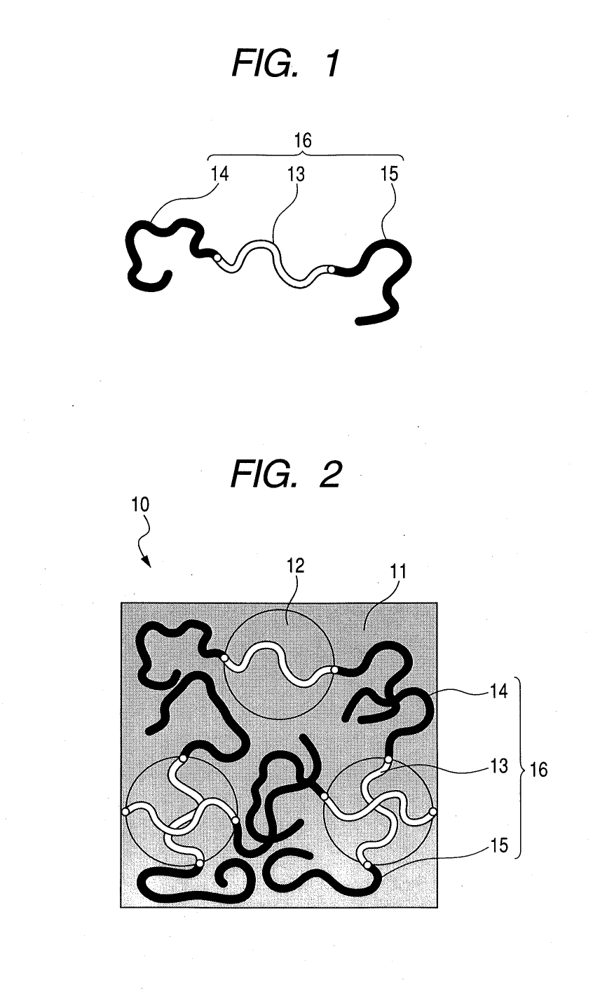

FIG. 1 is a schematic view illustrating one form of a polymer electrolyte according to the first aspect of the present invention.

The polymer electrolyte illustrated in FIG. 1 is a triblock copolymer 16 including an ion conductive segment A 13, a non-ion conductive segment B 14, and a non-ion conductive segment B 15 (hereinafter sometimes referred to as “B-A-B type triblock copolymer”).

The ion conductive segment A 13 in the B-A-B type triblock copolymer 16 forms an ion conductive domain 12 in a microphase separation structure of a polymer electrolyte membrane 10.

The ion conductive domain including the segment A can have a three-dimensional network in a microphase separation structure.

In the B-A-B triblock copolymer 16, the weight fraction W_{A} of the ion conductive segment A is 0.05<W_{A}<0.5, and the weight fraction of the non-ion conductive segment B W_{B} is 0.5<W_{B}<0.95. Here, when a molecular weight of the entire triblock copolymer is represented by M_{bcp}, the molecular weight of the segment A is represented by M_{A}, and the molecular weight of the segment B is represented by M_{B}, respective weight fractions are represented by the following formulae.

$${W}_{A} = \frac{{M}_{A}}{{M}_{bcp}}$$

$${W}_{B} = \frac{{M}_{B}}{{M}_{bcp}}$$

The molecular weight is represented by a number average molecular weight.

Also W_{A}+W_{B}=1.

In the case of W_{A}≧0.5, the microphase separation structure in which the ion conductive domain is the matrix may be easily formed into a polymer electrolyte membrane according to a second aspect of the invention (described later), but the stability of the membrane structure may be impaired under a humidified environment. Therefore, it may be necessary to provide W_{A}<0.5. Further, in the case of W_{A}≦0.05, the microphase separation structure may not be formed (i.e., compatiblized) into the polymer electrolyte membrane according to the second aspect of the invention (described later). Thus, it may be necessary to provide W_{A}>0.05.

In the block copolymer, the molecule typically may be rearranged so as to take the phase separation structure which is a thermodynamic equilibrium state by sufficiently treating the block copolymer with heat at a temperature equal to or higher than Tg after forming the membrane. At that time, the stable phase separation structure and its domain size may be determined depending on one or more of volume fractions, compatibility, and chain lengths (degrees of polymerization) of both domains. However, it can be difficult to exactly calculate the volume fraction. As a simpler method of determining the fraction of each segment, the weight fraction can be used. It should be noted that, in the phase separation structure in the equilibrium state, generally a spherical microphase separation structure tends to be selectively formed when the value of W_{A} is about 0.05 to 0.2, a cylindrical microphase separation structure tends to be selectively formed when the value of W_{A} is about 0.2 to 0.3, and a bi-continuous or lamellar microphase separation structure tends to be selectively formed when the value of W_{A} is about 0.3 to 0.7, as disclosed in Bates, F. S, and Fredrickson, G. H., Annu. Res. Phys. Chem., 41:525, 1990, which is herein incorporated by reference in its entirety. However, it has also been known that a numerical value of the above W_{A} may be changed depending on the compatibility and the degree of polymerization of the segments that form the block copolymer. Also, in embodiments of the present invention, the W_{A} value may not be limited to the above numerical value range when the electrolyte membrane having the predetermined phase separation structure can be otherwise obtained.

As described in further detail below, a microphase separation structure in a non-equilibrium state can be formed, for example, by evaporating a solvent either without heating or with heating at the temperature equal to or lower than Tg of the block copolymer, when the membrane is formed by evaporating the solvent from a block copolymer solution. The microphase separation structure in the non-equilibrium state may be relatively easily allowed to emerge by controlling at least one of a selective solvent, a mixed solvent ratio, and a film forming environment (e.g., air, nitrogen and humidity). For example, when the weight fraction of the ion conductive segment is relatively low, the ion conductive segment in the thermodynamically stable microphase separation structure may tend to become a spherical structure, but a cylindrical structure can also be formed by using the selective solvent as the solvent for forming the membrane.

It should be noted that, in embodiments of the present invention, any of the microphase separation structure in the equilibrium state and the microphase separation structure in the non-equilibrium state may be used.

Each segment will be described below.

The ion conductive segment A 13 may be a polymer having an ion exchange group and Tg of 40° C. or lower. The polymer having Tg of 40° C. or lower can be a polymer having at least one of an aliphatic hydrocarbon and an alicyclic hydrocarbon as a main chain. With a Tg of 40° C. or lower, the flexibility of the ion conductive segment A 13 may be enhanced, and an ion conductivity of the ion conductive domain 12 including the ion conductive segment A 13 may also be enhanced. In the claims and the specification of the present invention, the phrase “using an aliphatic hydrocarbon as the main chain” indicates a concept including both those having an aliphatic hydrocarbon as a main chain skeleton and those where a portion of atoms which form the main chain skeleton are substituted with an atom or a molecular group other than an aromatic ring. For example, a methylene group in the main chain may be substituted with an oxygen atom, an NH group, a carbonyl group, a carboxyl group, or an amide group. The phrase “having an alicyclic hydrocarbon as the main chain” is intended to refer to those having the substituted or unsubstituted alicyclic hydrocarbon group as the main chain skeleton, such as for example a maleimide structure having a cyclohexylene group. The main chain may also have one or more of a double bond and a triple bond contained therein.

As a monomer of a polymer having Tg of 40° C. or lower, for example, at least one of a conjugate diene monomer and an olefin-based monomer may be provided.

An ion exchange group can be selected, for example, from at least one of sulfonic acid, carboxylic acid, phosphoric acid, phosphonic acid, and phosphonous acid. In one version, the ion exchange group is selected from at least one of sulfonic acid, carboxylic acid, and phosphoric acid.

Examples of the ion conductive segment A 13 can include compounds obtained by adding a sulfonic acid group to a conjugate diene monomer or an olefin-based monomer. For example, the ion conductive segment A 13 can comprise at least one of sulfonic (sulfonate) group-containing styrene, sulfonic (sulfonate) group-containing (meth)acrylate, sulfonic (sulfonate) group-containing butadiene, sulfonic (sulfonate) group-containing isoprene, sulfonic (sulfonate) group-containing ethylene, and sulfonic (sulfonate) group-containing propylene.

It should be noted that the ion conductive segment A 13 may include one kind of the ion exchange group or two or more kinds of the ion exchange groups. The method of introducing those ion exchange groups is not particularly limited, for example, a monomer containing the ion exchange group may be polymerized to make a polymer, or alternatively the ion exchange group may be introduced in a polymer side chain by a polymer reaction after synthesizing a polymer containing no ion exchange group. In addition, the amount of the ion exchange group can be any amount that allows for the formation of the phase separation structure. An example of a method of introducing a sulfonic acid group into a polymer containing no ion exchange group by a polymer reaction may include, but is not limited to, sulfonation with fuming sulfuric acid, chlorosulfonic acid, concentrated sulfuric acid or cyclic sultone.

The non-ion conductive segments B 14 and B 15 are formed of a polymer having no ion exchange group and having at least one of an aliphatic hydrocarbon and an alicyclic hydrocarbon having a Tg of 70° C. or higher, such as 70° C. or higher to 200° C. or lower, as the main chain. When Tg is lower than 70° C., the flexibility of the non-ion conductive segment may become high and the structural stability in the polymer electrolyte membrane according to the second aspect of the present invention may be impaired due to the heat and water generated upon driving the fuel cell. Meanwhile, when Tg is 200° C. or higher, heat resistance may be enhanced, but it can become difficult to control the phase separation structure, and further, the flexibility of the electrolyte membrane may become poor and brittleness may be likely to appear. Thus, such a high Tg can cause cracking of the membrane resulting from a relatively faint impact during fabricating or driving of the fuel cell, and can sometimes cause property deterioration.

In one version, such non-ion conductive segments B 14 and B 15 may be hydrophobic polymers having at least one of aliphatic hydrocarbon and alicyclic hydrocarbon as the main chain. Examples of the non-ion conductive segments B 14 and B 15 can include polymers synthesized from monomers such as one or more of acrylates, methacrylates, styrene derivatives, conjugated dienes, and vinyl ester compounds. A monomer forming the hydrophobic polymers can comprise, for example, one or more of: styrene, and α-, o-, m-, p-alkyl-, alkoxyl-, halogen-, haloalkyl-, nitro-, cyano-, amide-, and ester-substituted styrene; polymerizable unsaturated aromatic compounds such as 2,4-dimethyl styrene, para-dimethylamino styrene, vinylbenzyl chloride, vinylbenzaldehyde, indene, 1-methylindene, acenaphthalene, vinylnaphthalene, vinylanthracene, vinylcarbazole, 2-vinylpyridine, 4-vinylpyridine, and 2-vinylfluorene; alkyl(meth)acrylates such as methyl (meth)acrylate, ethyl (meth)acrylate, n-propyl acrylate, n-butyl acrylate, 2-ethylhexyl (meth)acrylate, and stearyl (meth)acrylate; unsaturated monocarboxylates such as methyl crotonate, ethyl crotonate, methyl cinnamate, and ethyl cinnamate; fluoroalkyl (meth)acrylates such as trifluoroethyl (meth)acrylate, pentafluoropropyl (meth)acrylate, and heptafluorobutyl (meth)acrylate; siloxanyl compounds such as trimethylsiloxanyl dimethylsilylpropyl (meth)acrylate, tris(trimethylsiloxanyl)silylpropyl (meth)acrylate, and di(meth)acryloylpropyl dimethylsilylether; hydroxyalkyl (meth)acrylates such as 2-hydroxyethyl (meth)acrylate, 2-hydroxypropyl (meth)acrylate, and 3-hydroxypropyl (meth)acrylate; amine-containing (meth)acrylates such as dimethylaminoethyl (meth)acrylate, diethylaminoethyl (meth)acrylate, and t-butylaminoethyl (meth)acrylate; hydroxyalkyl esters of an unsaturated carboxylic acid, such as 2-hydroxyethyl crotonate, 2-hydroxypropyl crotonate, and 2-hydroxypropyl cinnamate; unsaturated alcohols such as (meth)allyl alcohol; unsaturated (mono)carboxylic acids such as (meth)acrylic acid, crotonic acid, and cinnamate acid; epoxy group-containing (meth)acrylates such as glycidyl (meth)acrylate, glycidyl α-ethylacrylate, glycidyl α-n-propyl acrylate, glycidyl α-n-butyl acrylate, 3,4-epoxybutyl (meth)acrylate, 6,7-epoxyheptyl (meth)acrylate, 6,7-epoxyheptyl α-ethyl acrylate, o-vinylbenzyl glycidyl ether, m-vinylbenzyl glycidyl ether, p-vinylbenzyl glycidyl ether, β-methylglycidyl (meth)acrylate, β-ethylglycidyl (meth)acrylate, β-propylglycidyl (meth)acrylate, methylglycidyl α-ethyl acrylate, 3-methyl-3,4-epoxybutyl (meth)acrylate, 3-ethyl-3,4-epoxybutyl (meth)acrylate, 4-methyl-4,5-epoxypentyl (meth)acrylate, 5-methyl-5,6-epoxyhexyl (meth)acrylate, β-methylglycidyl (meth)acrylate, and 3-methyl-3,4-epoxybutyl (meth)acrylate; monoesters or diesters thereof; maleimides such as N-methyl maleimide, N-butyl maleimide, N-phenyl maleimide, N-o-methylphenyl maleimide, N-m-methylphenyl maleimide, N-p-methylphenyl maleimide, N-o-hydroxyphenyl maleimide, N-m-hydroxyphenyl maleimide, N-p-hydroxyphenyl maleimide, N-methoxyphenyl maleimide, N-m-methoxyl phenyl maleimide, N-p-methoxyphenyl maleimide, N-o-chlorophenyl maleimide, N-m-chlorophenyl maleimide, N-p-chlorophenyl maleimide, N-o-carboxyphenyl maleimide, N-p-carboxyphenyl maleimide, N-p-nitrophenyl maleimide, N-ethyl maleimide, N-cyclohexylmaleimide, and N-isopropyl maleimide; (meth)acrylonitrile; and vinyl chloride.

In one version, the non-ion conductive segments B 14 and B 15 may be formed of monomers comprising at least one of polymerizable unsaturated aromatic compounds, alkyl (meth)acrylates, epoxy group-containing (meth)acrylate esters, maleimides and acrylonitrile.

A second aspect of the present invention will be described.

The second aspect of the present invention relates to a polymer electrolyte membrane having the microphase separation structure, including a triblock copolymer including a segment A which has a glass transition temperature of 40° C. or lower and is ion conductive, and a segment B which has a glass transition temperature of 70° C. or higher and is non-ion conductive, the segment A and segment B being connected in a sequence B-A-B, in which the weight fraction W_{A} of the segment A in the triblock copolymer is 0.05<W_{A}<0.5.

FIG. 2 is a conceptual view of one form of the second polymer electrolyte membrane of the present invention.

The polymer electrolyte membrane 10 which is one form of the polymer electrolyte membrane according to the second aspect the present invention has the microphase separation structure including an ion conductive domain 12 and a non-ion conductive domain 11. The ion conductive domain 12 is formed of the ion conductive segment A 13 which the triblock copolymer 16 described according to the first aspect of the present invention has therein. The non-ion conductive domain 11 is formed of the non-ion conductive domains B 14 and B 15.

The ion conductive domain 12 is a proton-conducting portion in the microphase separation structure and forms a continuous phase in the microphase separation structure of the polymer electrolyte membrane. Here, the continuous phase indicates that an aspect ratio (b)/(a) of a diameter (width) (a) and a length (b) of the domain in the microphase separation membrane is 10 or more.

In addition, the non-ion conductive domain 11 formed of the non-ion conductive segment B14 is hydrophobic and may have a function of maintaining the shape of the polymer electrolyte membrane.

In a microphase separation electrolyte membrane in an ordinary diblock copolymer, both domains and the membrane structure are formed only by entanglement of polymer chains. In contrast, in the case of the microphase separation electrolyte membrane using the B-A-B type triblock copolymer, the ion conductive domain 12 serves as a fixation point of a bridging structure between the polymer chains of the adjacent hydrophobic segments 14 to support the electrolyte membrane structure, in addition to the factor of the entanglement. Thus, the polymer electrolyte membrane using the B-A-B type triblock copolymer may allow the realization of relatively high membrane structure stability and the high mechanical strength when impregnated with water.

In one version, the microphase separation structure formed of the ion conductive domain 12 and the non-ion conductive domain 11 includes a structure in which the non-ion conductive domain 11 is a matrix phase and the ion conductive domain 12 has a cylindrical shape, a structure in which the non-ion conductive domain 11 is the matrix phase and the ion conductive domain 12 has a shape making a continuous phase in the three-dimensional structure (referred to as a bi-continuous structure in the art), and a structure in which the ion conductive domain 12 and the non-ion conductive domain 11 form a lamellar structure.

When the shape of the continuous phase of the ion conductive domain 12 is a cylindrical or three-dimensional structure and the non-ion conductive domain 11 is the matrix phase, the ion conductive domain may abundantly encapsulate the ion exchange group which covers the ion conduction, and may contribute to excellent proton conductivity under low humidity.

It should be noted that the “structure in which the non-conductive domain 11 formed of the non-ion conductive segments B 14 and B 15 is the matrix phase for the ion conductive domain 12” is, in other words, the “structure in which the non-conductive domain surrounds the ion conductive domain”. Here, for the non-conductive domain surrounding the ion conductive domain, the entire ion conductive domain need not be surrounded completely, as long as a majority of the ion conductive domain is surrounded by the non-conductive domain.

In the case of the structure in which the ion conductive domain 12 and the non-ion conductive domain 11 have the lamellar structures, since there may be no matrix phase which maintains the membrane structure, the membrane structure stability and strength when impregnated with water may sometimes be inferior to those in the cylindrical or bi-continuous phase separation membrane. However, if the stability and the strength are within a range which is acceptable for producing the fuel cell and acceptable for use under the environment for driving the fuel cell, then the volume fraction occupied by the ion conductive domain in the membrane may be increased compared with those in the cylindrical or bi-continuous phase separation structure, and thus it may sometimes be the case that good proton conductivity and enhancement of water dispersibility in the electrolyte membrane can be provided. In the lamellar structure, it may not be the case that the weight fraction W_{A} of the ion conductive segment A 13 is more than 0.5, because the swelling due to the water generated with power generation may be severe.

Therefore, at least one of the cylindrical, bi-continuous and lamellar phase separation structures can be appropriately selected depending on the properties of the fuel cell.

A membrane thickness of the polymer electrolyte membrane 10 may not be particularly limited as long as a self-standing membrane may be obtained, and can be for example 1 μm or more to 500 μm or less.

A method of making the polymer electrolyte will be described.

The method of synthesizing the triblock copolymer may not be particularly limited, and can be optionally selected depending on at least one of a monomer type, its use and simplicity and easiness of synthesis. For example, the triblock copolymer can be synthesized by the following methods.

(1) A monomer having the ion exchange group may be polymerized to synthesize the ion conductive block 13, and subsequently a monomer which exhibits no ion conductivity may be copolymerized at both ends thereof to synthesize the non-ion conductive blocks 14 and 15.

(2) The non-ion conductive block 14 may be synthesized, and subsequently, a monomer having the ion exchange group may be copolymerized at its one end to synthesize the ion conductive block 13, and further the non-ion conductive monomer may be copolymerized at the end of the ion conductive block to synthesize the non-ion conductive block 15.

(3) The ion conductive block 13 having the ion exchange group and the non-ion conductive blocks 14 and 15 may be synthesized independently, and then made into one block by a polymer reaction.

(4) A triblock copolymer where the components do not have the ion conductivity may be synthesized, and subsequently an ion exchange group may be introduced into only the block portion in the middle of the triblock to form the ion conductive block 13.

As the method of synthesizing the triblock copolymer, when a living polymerization method is used, it may be possible to freely control the degree of polymerization of block chains to synthesize the copolymer. The living polymerization method includes various polymerization methods such as living anionic polymerization, living cationic polymerization, coordination polymerization and living radical polymerization. Those polymerization methods do not particularly limit the present invention. In one version, the living radical polymerization method may be used. For the living radical polymerization method, various techniques have been developed in recent years, and the following various examples are included.

Examples of the living radical polymerization technique can include: iniferter polymerization shown in Macromol. Chem. Rapid Commun. 1982, vol. 3, p. 133; a technique using a radical scavenger such as a nitroxide compound shown in Macromolecules, 1994, vol. 27, p. 7228; atom transfer radical polymerization (ATRP) using an organic halide as an initiator and a transition-metal complex as a catalyst shown in J. Am. Chem. Soc., 1995, vol. 117, p. 5614; and reversible addition-fragmentation chain transfer polymerization (RAFT) shown in Macromolecules, 1998, vol. 31, p. 5559, each of which references is hereby incorporated by reference herein in its entirety. Use of those polymerization techniques may enable the polymerization of, for example, various vinyl monomers.

A method of producing the polymer electrolyte membrane having the microphase separation structure will be described.

According to one embodiment, the polymer electrolyte membrane having the microphase separation structure can be formed by (1) a step of making a solution by dissolving the B-A-B type triblock copolymer including the ion conductive segment and the non-ion conductive segments in a solvent, (2) a step of applying the solution produced in (1) on a substrate surface, and (3) a step of evaporating the solvent in the solution applied on the substrate in (2).

The following step may also optionally be used: (4) a step of treating the membrane produced in (3) to anneal at a temperature which is equal to or higher than Tgs of the ion conductive segment and the non-ion conductive segment and is equal to or lower than a phase transition temperature of the block copolymer.

Each step will be described in detail below.

In the step (1), the B-A-B type triblock copolymer including the ion conductive segment and the non-ion conductive segment is dissolved in the solvent to make the solution.

As the solvent dissolving the B-A-B type triblock copolymer, substances may be used that substantially uniformly dissolve the triblock copolymer and substantially do not react with the triblock copolymer. Specific examples of the solvent may include: aromatic hydrocarbon-based solvents such as benzene and toluene; ether-based solvents such as tetrahydrofuran and 1,4-dioxane; halogenated hydrocarbon-based solvents such as methylene chloride and chloroform; ketone-based solvents such as acetone, methyl ethyl ketone, and cyclohexanone; alcohol-based solvents such as methanol, ethanol, propanol, isopropanol, n-butanol, and t-butanol; nitrile-based solvents such as acetonitrile and benzonitrile; ester-based solvents such as ethyl acetate and butyl acetate; carbonate-based solvents such as ethylene carbonate and propylene carbonate; propylene glycol alkylether acetates such as propylene glycol methylether acetate and propylene glycol ethylether acetate; and N,N-dimethylformamide, N,N-dimethylacetamide, N-methylpyrrolidone, dimethylimidazolidinone, dimethylsulfoxide, and water. Those solvents may be used alone or two or more kinds may be used in mixture.

In the step (2), the solution made in (1) is applied onto the substrate surface.

As a method of applying the solution, for example, application methods such as at least one of a spin coating method, a dipping method, a bar coating method, a spray method, and a casting method can be used.

In the step (3), the solvent in the solution applied onto the substrate is evaporated.

According to one embodiment, when the solvent is evaporated, the solvent may be evaporated without heating or may be evaporated by heating at the temperature equal to or lower than the Tg of the block copolymer. By evaporating the solvent without heating, or by heating at relatively low temperatures, and by controlling the membrane forming conditions (e.g., at least one of selective solvent, mixed solvent ratio, and membrane forming environment) as described above, it may be possible to control the microphase separation structure in the non-equilibrium state which appears immediately after applying the polymer solution onto the substrate and drying it, and to substantially prevent degradation of the polymer which can otherwise be caused by heating.

In the step (4), the microphase separation structure in the thermodynamic equilibrium state is formed.

The microphase separation membrane in the non-equilibrium state formed in (3) may be annealed at the temperature which is equal to or higher than the Tg of the block copolymer and is equal to or lower than the phase transition temperature of the block copolymer, and subsequently, the microphase separation structure may be fixed at room temperature.

At that time, the triblock copolymer may be molded into a predetermined shape upon melting using a method such as a hot press method or an injection molding method.

A third aspect of the present invention will be described.

The third aspect of the present invention is generally directed to a polymer electrolyte membrane including a triblock copolymer having: a segment A which has a glass transition temperature of 40° C. or lower and is ion conductive and a segment B which has the glass transition temperature of 70° C. or higher and is non-ion conductive, the segment A and the segment B being connected in a sequence of B-A-B, in which an ion conductive domain including the segment A forms a continuous phase and a non-ion conductive domain including the segment B forms a matrix phase in a microphase separation structure formed by the triblock copolymer.

In other words, the third aspect of the present invention is directed to the polymer electrolyte membrane including the B-A-B type triblock copolymer, where the non-ion conductive segments B having Tg of 70° C. or higher are connected to both ends of the ion conductive segment A having Tg of 40° C. or lower.

Differences between the third aspect of the present invention and the above-described second aspect of the present invention may include that the weight fraction of the segment A and segment B are not limited to a particular range, the non-ion conductive domain forms the matrix phase, and the ion conductive domain forms the continuous phase in the triblock copolymer constituting the polymer electrolyte membrane according to the third aspect of the present invention.

The microphase separation structure of the polymer electrolyte membrane can have a shape such as at least one of a cylindrical shape or a three-dimensional network. In any shape, the matrix phase is formed of the non-ion conductive domain including the non-ion conductive segment B of the triblock copolymer. The continuous phase (i.e., a cylinder portion in the cylindrical shape, a network portion in the three-dimensional network) is formed of the ion conductive domain including the ion conductive segment A of the triblock copolymer.

Here, in the third aspect of the present invention, the phrase “the non-ion conductive domain is the matrix phase” means, in other words, “the structure in which the non-ion conductive domain surrounds the ion conductive domain,” as with the second aspect of the present invention. In the third aspect of the present invention, the matrix phase is formed of the non-ion conductive domain, thereby enhancing the stability and strength of the membrane structure.

It should be noted that the triblock copolymer which forms the third polymer electrolyte membrane of the present invention may be the polymer electrolyte shown in the first aspect of the present invention.

A membrane electrode assembly corresponding to a fourth aspect of the present invention will be described.

An embodiment of a membrane electrode assembly of the fourth aspect of the present invention, as illustrated for example in FIG. 6, can be produced by placing catalyst layers on both sides of the second or third polymer electrolyte membrane according to the present invention as described above. The membrane electrode assembly 20 includes at least one of the second and third polymer electrolyte membranes 21 of the present invention, and the catalyst layer 22 and the catalyst layer 23 which are two catalyst layers (i.e., anode and cathode) mutually opposed to each other by sandwiching the membrane.

As the catalyst layer, a structure body including at least one of platinum and an alloy of platinum with a metal such as ruthenium (other than platinum), or a layer obtained by allowing such a structure body to be dispersed and supported on a supporter such as carbon, can be used. The structure body may have, for example, a particle shape or may have a dendritic shape.

A method of producing the membrane electrode assembly can include one or more of a method of directly forming the catalyst layers on a surface of the polymer electrolyte membrane, a method in which the catalyst layer is formed on a polymer film such as PTFE, and then the catalyst layer is transferred onto the membrane by hot-pressing the catalyst layer and the electrolyte membrane, and a method in which the catalyst layer is formed on the electrode such as a gas diffusion layer and then joined with the electrolyte membrane.

A fuel cell according to a fifth aspect of the present invention will be described.

The fuel cell 30 according to the fifth aspect of the present invention can be produced by, for example, a technique using one of the second and third polymer electrolyte membranes of the present invention and the membrane electrode assembly of the fourth aspect of the present invention. The fuel cell 30 can include at least the membrane electrode assembly provided with the electrodes on both sides of the polymer electrolyte membrane described above, and a current collector.

An example of the fuel cell 30 includes the membrane electrode assembly 20, a pair of separators 31 and 37 holding the membrane electrode assembly, current collectors 32 attached to the separators, the gas diffusion layer 33, and packings 34. The separator 31 on the anode side may have an anode side flow path 35 to feed a gaseous fuel or a liquid fuel such as hydrogen or alcohols, such as for example, methanol. On the other hand, the separator 37 on the cathode side may have a cathode side flow path 36 to feed an oxidizer gas such as oxygen gas or air. It should be noted that in one version, instead of the separator, or between the separator and the gas diffusion layer, there may also be arranged a gas flow path made of a porous conductor such as a foam metal.

The present invention is illustrated in detail with reference to Examples below without limiting the invention thereto in any way.

Initially, polymers were synthesized by the procedures shown below.

### Synthesis Example 1

### Synthesis of B-A-B Type Triblock Copolymer

In a nitrogen atmosphere, there were mixed 2.34 mmol of copper(I) bromide, 2.34 mmol of hexamethyltriethylenetetramine, 2.34 mmol of dimethyl 2,6-dibromoheptanedionate, and 234 mmol of tert-butyl acrylate (tBA) in dimethylformamide (DMF). The dissolved oxygen in the mixture was replaced with nitrogen. The mixture was allowed to react at 70° C. while monitoring the monomer conversion through gas chromatography. The reaction was stopped by quenching the reaction mixture with liquid nitrogen. The molecular weight of the resultant poly-tBA was confirmed by GPC to find that Mn was 11,600 and Mw/Mn was 1.20.

Then, 0.261 mmol of the obtained poly-tBA having bromine at both ends, 0.522 mmol of copper(I) bromide, 0.522 mmol of hexamethyltriethylenetetramine, and 156.5 mmol of styrene monomer were mixed and the mixture was subjected to replacement by nitrogen. The mixture was allowed to react at 100° C. The reaction was stopped by quenching with liquid nitrogen. Then, the resulting polymer was purified by reprecipitation into methanol, whereby a PSt-b-PtBA-b-PSt triblock copolymer was obtained. The molecular weight of the obtained PSt-b-PtBA-b-PSt triblock copolymer (b denotes block copolymerization) was confirmed by GPC to find that Mn was 40,100 and Mw/Mn was 1.42. From this result, the molecular weights of the respective blocks were calculated to be 11,600 for the PtBA segment, and 28,500 for the PSt segment. The results were consistent with the compositional ratio of both blocks derived from the peak integral value ratio in ¹H-NMR.

Next, the obtained block copolymer was mixed with trifluoroacetic acid (5 equivalents to t-butyl group) at room temperature in chloroform to deprotect the tert-butyl group of the PtBA segment to thereby convert the tert-butyl group to a carboxyl acid. Thus, a (polystyrene)-b-(polyacrylic acid)-b-(polystyrene) (PSt-b-PAA-b-PtBA-b-PSt) triblock copolymer was obtained. Further, a triblock copolymer (BP-1) having non-ion conductive segments including polystyrene at both ends of a sulfonic acid-containing segment was obtained through the sulfonation of the PAA segment by dissolving the resulting polymer in DMF, adding sodium hydride (5 equivalents relative to carboxylic acid) and 1,3-propanesultone (20 equivalents relative to carboxylic acid), and heating with reflux. A weight fraction of the ion conductive segment A in BP-1 was calculated, and was W_{A}=0.281. The weight fraction of polystyrene (non-ion conductive segment B) was W_{B}=0.719. The structural formula of the block copolymer BP-1 is shown below.

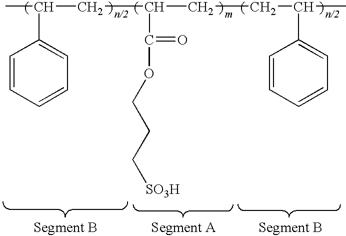

A glass transition temperature (Tg) of the block copolymer BP-1 was measured using a differential scanning calorimeter (DSC), and, Tg of the sulfonic acid-containing segment (corresponding to the ion conductive segment A) was 27° C. and Tg of the polystyrene segment (corresponding to the non-ion conductive segment B) was 102° C.

### Synthesis Example 2

### Synthesis of A-B-A Type Triblock Copolymer

In a nitrogen atmosphere, 1.296 mmol of copper(I) bromide, 1.296 mmol of pentamethyl diethylenetriamine, 0.894 mmol of dimethyl 2,6-dibromoheptanedioate, and 432 mmol of styrene monomer were mixed, dissolved oxygen was replaced with nitrogen, and then their reaction was performed at 100° C. The reaction was performed while the monomer conversion was confirmed by gas chromatography, and was stopped by quenching the reaction mixture with liquid nitrogen. As a result of confirming the molecular weight of the yielded polystyrene by GPC, Mn was 34,700 and Mw/Mn was 1.20.

Subsequently, 0.072 mmol of the yielded polystyrene having bromine in its both ends, 0.720 mmol of copper(I) bromide, 0.720 mmol of pentamethyl diethylenetriamine, and 43.2 mol of tert-butyl acrylate (tBA) were mixed in DMF, and nitrogen replacement was performed. The reaction was performed at 80° C., and subsequently was stopped by quenching the reaction mixture with liquid nitrogen. After purifying by reprecipitation into methanol, the molecular weight of the yielded PtBA-b-PSt-b-PtBA triblock copolymer was confirmed by GPC. As a result, Mn was 50,400 and Mw/Mn was 1.13. From the result, the molecular weights of the PtBA segment and the PSt segment were calculated to be 15,700 and 34,700, respectively, which were consistent with the compositional ratio of both blocks obtained from the peak integral value ratio in ¹H-NMR.

Then, a tert-butyl group in the PtBA segment was deprotected to convert to carboxylic acid and yield a (polyacrylic acid)-b-(polystyrene)-b-(polyacrylic acid) (PAA-b-PSt-b-PAA) triblock copolymer by mixing the yielded block copolymer with trifluoroacetic acid (5 equivalents relative to the tert-butyl group) in chloroform at room temperature. Further, a triblock copolymer (BP-2) having sulfonic acid-containing segments at both ends of the non-ion conductive segment including polystyrene was yielded through the sulfonation of the PAA segment by dissolving the yielded copolymer in DMF, adding sodium hydride (5 equivalents relative to carboxylic acid) and 1,3-propanesultone (20 equivalents relative to carboxylic acid), and heating with reflux. The weight fraction of the ion conductive segment A in BP-2 was calculated, and was W_{A}=0.293. The weight fraction of polystyrene (non-ion conductive segment B) was W_{B}=0.707. The structural formula of the block copolymer BP-2 is shown below.

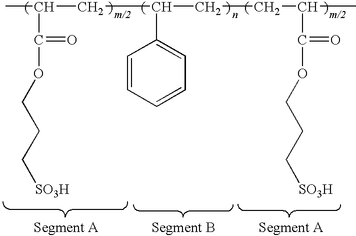

### Synthesis Example 3

### Synthesis of A-B Type Diblock Copolymer

In a nitrogen atmosphere, 3.51 mmol of copper(I) bromide, 3.51 mmol of hexamethyl triethylenetetramine, 2.34 mmol of MBrP, and 234 mmol of tert-butyl acrylate (tBA) were mixed in dimethylformamaide (DMF), dissolved oxygen was replaced with nitrogen, and then their reaction was performed at 70° C. The reaction was performed while the monomer conversion was confirmed by gas chromatography, and was stopped by quenching the reaction mixture with liquid nitrogen. As a result of confirming the molecular weight of the yielded poly tBA by GPC, Mn was 10,100 and Mw/Mn was 1.11.

Subsequently, 0.20 mmol of the yielded poly tBA having bromine in its one end, 0.20 mmol of copper(I) bromide, 0.20 mmol of hexamethyl triethylenetetramine, and 120 mmol of styrene monomer were mixed, and nitrogen replacement was performed. The reaction was performed at 100° C., and subsequently was stopped by quenching the reaction mixture with liquid nitrogen. After purifying by reprecipitation into methanol, the molecular weight of the yielded PtBA-b-PSt diblock copolymer was confirmed by GPC. As a result, Mn was 35,700 and Mw/Mn was 1.15. From the result, the molecular weights of the PtBA segment and the PSt segment were calculated to be 10,100 and 25,600, respectively, which were consistent with the compositional ratio of both blocks obtained from the peak integral value ratio in ¹H-NMR.

Then, a tert-butyl group in the PtBA segment was deprotected to convert to carboxylic acid and yield a (polyacrylic acid)-b-(polystyrene) (PAA-b-PSt) diblock copolymer by mixing the yielded block copolymer with trifluoroacetic acid (5 equivalents relative to the tert-butyl group) in chloroform at room temperature. Further, a diblock copolymer (BP-3) having a sulfonic acid-containing segment and the non-ion conductive segment including polystyrene was yielded through the sulfonation of the PAA segment by dissolving the yielded copolymer in DMF, adding sodium hydride (5 equivalents relative to carboxylic acid) and 1,3-propanesultone (20 equivalents relative to carboxylic acid), and heating with reflux. The weight fraction of the ion conductive segment A in BP-3 was calculated, and was W_{A}=0.283. The weight fraction of polystyrene (non-ion conductive segment B) was W_{B}=0.717. The structural formula of the block copolymer BP-3 is shown below.

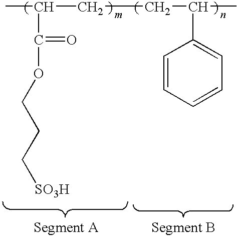

### Synthesis Example 4

### Synthesis of B-A-B Type Triblock Copolymer

In a nitrogen atmosphere, 1.85 mmol of copper(I) bromide, 1.85 mmol of pentamethyl diethylenetriamine, 0.925 mmol of dimethyl 2,6-dibromoheptanedioate, and 185 mmol of 4-acetoxystyrene (AcOSt) were mixed, dissolved oxygen was replaced with nitrogen, and then their reaction was performed at 100° C. The reaction was performed while the monomer conversion was confirmed by gas chromatography, and was stopped by quenching the reaction mixture with liquid nitrogen. As a result of confirming the molecular weight of the yielded poly AcOSt by GPC, Mn was 18,100 and Mw/Mn was 1.19.

Subsequently, 0.139 mmol of the yielded poly AcOSt having bromine at both of its ends, 1.12 mmol of copper(I) bromide, 1.12 mmol of pentamethyl diethylenetriamine, and 111.1 mmol of styrene monomer were mixed, and nitrogen replacement was performed. The reaction was performed at 110° C., and subsequently was stopped by quenching the reaction mixture with liquid nitrogen. After purifying by reprecipitation into methanol, the molecular weight of the yielded PSt-b-PAcOSt-b-PSt triblock copolymer was confirmed by GPC. As a result, Mn was 74,400 and Mw/Mn was 1.60. Further, the composition ratio of both blocks obtained from the peak integral value ratio in ¹H-NMR was found to be PAcOSt/PSt=123/320.

Then, an acetyl group in the PAcOSt segment was deprotected to convert to a hydroxyl group and yield a (polystyrene)-b-(polyhydroxystyrene)-b-(polystyrene) (PSt-b-PHS-b-PSt) triblock copolymer by mixing the yielded block copolymer with hydrazine (18 equivalents relative to the acetyl group) in 1,4-dioxane at room temperature. Further, a triblock copolymer (BP-4) having the non-ion conductive segment including polystyrene at both ends of a sulfonic acid-containing segment was yielded through the sulfonation of the PHS segment by dissolving the yielded copolymer in DMF, adding sodium hydride (5 equivalents relative to a hydroxyl group) and 1,3-propanesultone (20 equivalents relative to a hydroxyl group), and heating with reflux. The weight fraction of the ion conductive segment A in BP-4 was calculated, and was W_{A}=0.421. The weight fraction of polystyrene (non-ion conductive segment B) was W_{B}=0.579. The structural formula of the block copolymer BP-4 is shown below.

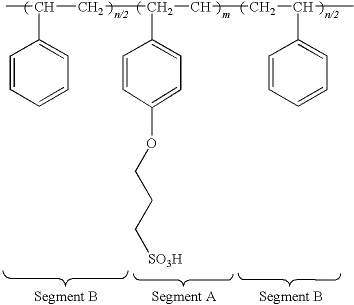

A glass transition temperature (Tg) of the block copolymer BP-4 was measured using DSC in the same way as in Synthesis Example 1, and, Tg of the sulfonic acid-containing segment (corresponding to the ion conductive segment A) was −8° C., and Tg of the polystyrene segment (corresponding to the non-ion conductive segment B) was 97° C.

### Synthesis Example 5

### Synthesis of B-A-B Type Triblock Copolymer

In a nitrogen atmosphere, 0.188 mmol of copper(I) bromide, 0.188 mmol of pentamethyl diethylenetriamine, 0.375 mmol of dimethyl 2,6-dibromoheptanedioate, and 37.5 mmol of (2-acryoloxyethoxy)-trimethylsilane (HEA-TMS) were mixed, dissolved oxygen was replaced with nitrogen, and then their reaction was performed at 80° C. The reaction was performed while the monomer conversion was confirmed by gas chromatography, and was stopped by quenching the reaction mixture with liquid nitrogen. As a result of confirming the molecular weight of yielded poly HEA-TMS by GPC, Mn was 14,500 and Mw/Mn was 1.14.

Subsequently, 0.172 mmol of the yielded poly HEA-TMS having bromine at both of its ends, 0.172 mmol of copper(I) bromide, 0.172 mmol of hexamethyl triethylenetetramine, and 103.4 mmol of styrene monomer were mixed, and nitrogen replacement was performed. The reaction was performed at 100° C., and subsequently was stopped by quenching the reaction mixture with liquid nitrogen. After purifying by reprecipitation into methanol, the molecular weight of the yielded PSt-b-PHEA-TMS-b-PSt triblock copolymer was confirmed by GPC. As a result, Mn was 35,200 and Mw/Mn was 1.27. Further, the compositional ratio of both blocks obtained from the peak integral value ratio in ¹H-NMR was found to be PHEA-TMS/PSt=76/220.

Then, the trimethylsilyl group in the PHEA-TMS segment was deprotected to convert to a hydroxyl group and yield a (polystyrene)-b-(polyhydroxyethyl acrylate)-b-(polystyrene) (PSt-b-PHEA-b-PSt) triblock copolymer by mixing the yielded block copolymer with 5 ml of hydrochloric acid in THF at room temperature. Further, a triblock copolymer (BP-5) having the non-ion conductive segment including polystyrene in both ends of a sulfonic acid-containing segment was yielded through the sulfonation of the PHEA segment by dissolving the yielded copolymer in DMF, adding sodium hydride (5 equivalents relative to a hydroxyl group) and 1,3-propanesultone (20 equivalents relative to a hydroxyl group), and heating with reflux. The weight fraction of the ion conductive segment A in BP-5 was calculated, and was W_{A}=0.441. The weight fraction of polystyrene (non-ion conductive segment B) was W_{B}=0.559. The structural formula of the block copolymer BP-5 is shown below.

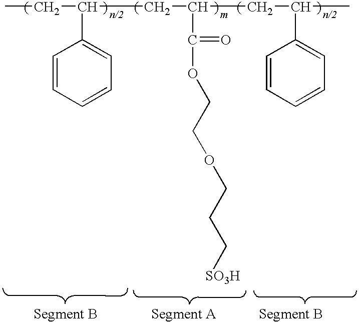

For the block copolymer BP-5, Tg was measured using DSC in the same way as in Synthesis Example 1, and Tg of the sulfonic acid-containing segment (corresponding to the ion conductive segment A) was −37° C., and Tg of the polystyrene segment (corresponding to the non-ion conductive segment B) was 104° C.

### Example 1

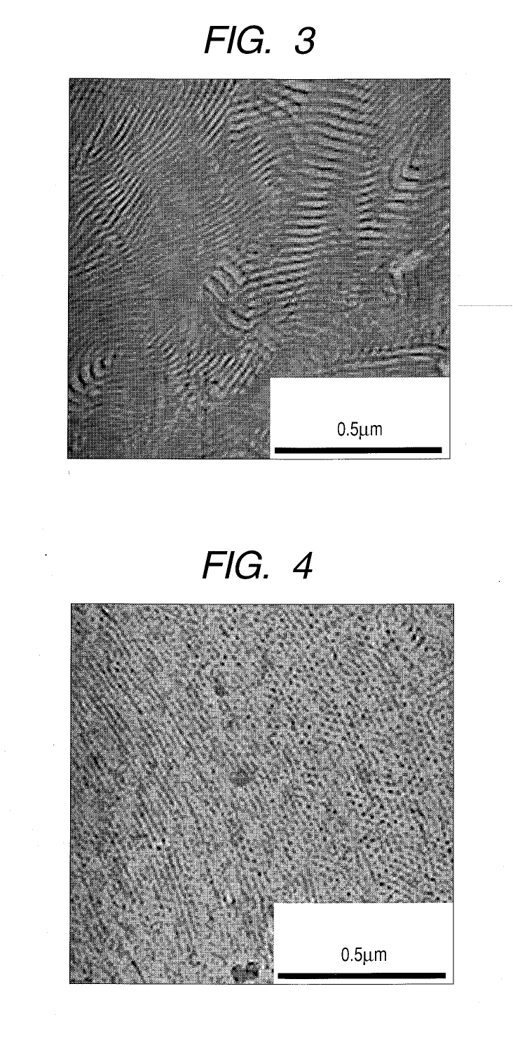

The B-A-B type triblock copolymer BP-1 obtained in Synthesis Example 1 was dissolved in a mixed solvent of THF/methanol so that a solid content concentration was 20% by weight. The resultant was then applied onto a glass substrate by a casting method to obtain a membrane having a thickness of 50 μm. A cross-section of the obtained electrolyte membrane was observed under a transmission electron microscope (TEM). The result is shown in FIG. 3. From the TEM photograph, it was confirmed that the ion conductive segment A and the non-ion conductive segment B formed a lamellar microphase separation structure in the electrolyte membrane of Example 1.

Evaluation of Proton Conductivity

For the obtained electrolyte membrane, a resistance of the electrolyte membrane was measured by an AC impedance method (frequencies of 10 Hz to 1 kHz, applied electric voltage: 10 mV) using a four terminal method in an incubator at constant temperature and constant humidity. The ion conductivity was obtained from its membrane thickness.

The proton conductivity at a temperature of 50° C. and a relative humidity of 50% was found to be 1.11×10⁻² S/cm.

Evaluation of Shape/Size Stability Against Water

The electrolyte membrane was immersed in purified water for 3 hours, and then its change was observed visually. The case where no change both in shape and size was found was ranked as “A”, the case where the shape was kept but swelling was found was ranked as “B”, and the case where the membrane was broken and the shape was not kept was ranked as “C”.

For the BP-1 cast membrane, after immersing in the purified water for 3 hours, no change both in shape and size was observed.

Evaluation of Mechanical Strength of Membrane.

In order to evaluate the mechanical strength of the membrane, strips (length: 3 cm) of the BP-1 cast membrane were made, and a tension test was performed using a micro autograph MST-1 (manufactured by Shimadzu Corporation) to measure a breaking strength and a breaking extension.

As a result of evaluating the mechanical strength of the membrane, the breaking strength was determined to be 18.1 MPa and the breaking extension was determined to be 17%. The results of evaluating the proton conductivity, the shape/size stability for water, and the mechanical strength of the membrane were summarized in Table 1.

Gas permeability in the BP-1 cast membrane was measured using the JIS k-7126 Second differential pressure GC method. As a result, hydrogen permeability at 40° C. under a dry condition was determined to be 4.1×10³ cm³/m²·24 h·atm, and the hydrogen permeability at 40° C. at a relative humidity of 90% was determined to be 3.4×10⁴ cm³/m²·24 h·atm in the cast membrane of Example 1.

### Example 2

The B-A-B type triblock copolymer BP-1 obtained in Synthesis Example 1 was dissolved in a mixed solvent of dioxane/isopropyl alcohol so that a solid content concentration was 20% by weight. The resultant was then applied onto a glass substrate by a casting method to obtain a membrane having a thickness of 50 μm. A cross-section of the obtained electrolyte membrane was observed under TEM. The result is shown in FIG. 4. From the TEM photograph, it was confirmed that the electrolyte membrane of Example 2 formed a microphase separation structure consisting of a matrix phase with the non-ion conductive segment B and a cylindrical continuous phase with the ion conductive segment A.

For the electrolyte membrane, the proton conductivity, the shape/size stability against water, and the mechanical strength of the membrane were evaluated in the same way as in Example 1. The results are summarized in Table 1.

### Example 3

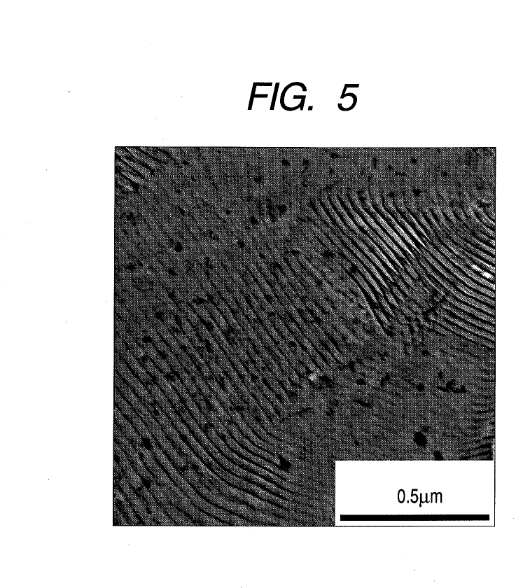

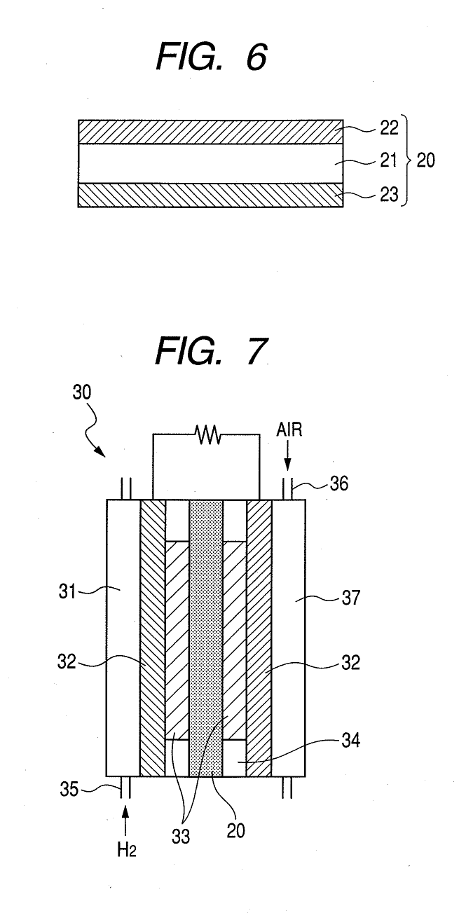

The B-A-B type triblock copolymer BP-4 obtained in Synthesis Example 4 was dissolved in dimethylacetamide so that a solid content concentration was 17% by weight. The resultant was then applied onto a glass substrate by a casting method to obtain a membrane having a thickness of 40 μm. A cross-section of the obtained electrolyte membrane was observed under TEM. The result is shown in FIG. 5. From the TEM photograph, it was confirmed that the ion conductive segment A and the non-ion conductive segment B formed a lamellar microphase separation structure in the electrolyte membrane of Example 3.

For the electrolyte membrane, the proton conductivity, the shape/size stability against water, and the mechanical strength of the membrane were evaluated in the same way as in Example 1. The results are summarized in Table 1.

### Example 4

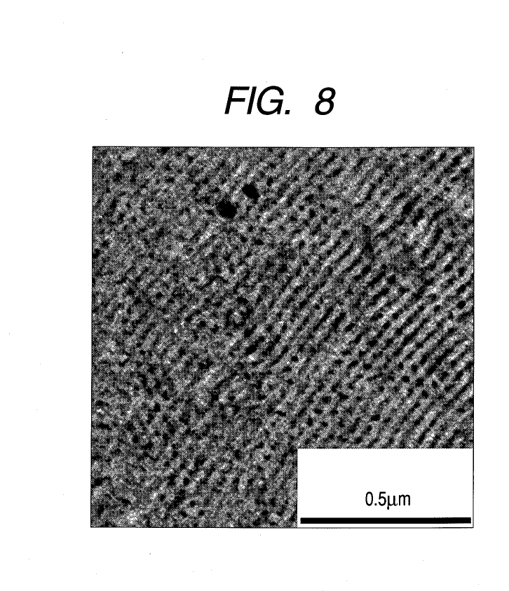

The B-A-B type triblock copolymer BP-5 obtained in Synthesis Example 5 was dissolved in a mixed solvent of THF/methanol so that a solid content concentration was 17% by weight. The resultant was then applied onto a glass substrate by a casting method to obtain a membrane having a thickness of 75 μm. A cross-section of the obtained electrolyte membrane was observed under TEM. The result is shown in FIG. 8. From the TEM photograph, it was confirmed that the electrolyte membrane of Example 4 formed a microphase separation structure consisting of a cylindrical continuous phase with the ion conductive segment A and a matrix phase with the non-ion conductive segment B.

For the electrolyte membrane, the proton conductivity was evaluated, and a water resistance test and a tension test were performed in the same way as in Example 1. The results are summarized in Table 1.

### Example 5

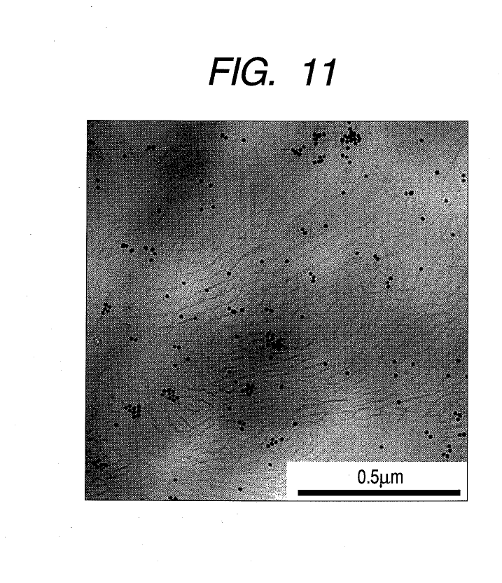

The B-A-B type triblock copolymer BP-1 obtained in Synthesis Example 1 was dissolved in N,N-dimethylformamide so that a solid content concentration was 18% by weight. The resultant was then applied onto a glass substrate by a casting method to obtain a membrane having a thickness of 60 μm. A cross-section of the obtained electrolyte membrane was observed under TEM. The result is shown in FIG. 11. As a result of the TEM photograph and three-dimensional TEM analysis, it was confirmed that the electrolyte membrane of Example 5 formed a microphase separation structure consisting of a continuous phase of a three dimensional network with the ion conductive segment A and a matrix phase with the non-ion conductive segment B (bi-continuous structure).

For the electrolyte membrane, the proton conductivity was evaluated, and a resistance test and a tension test were performed in the same way as in Example 1. The results are summarized in Table 1.

### Comparative Example 1

The A-B-A type triblock copolymer BP-2 obtained in Synthesis Example 2 was dissolved in a mixed solvent of THF/methanol so that a solid content concentration was 20% by weight. The resultant was then applied onto a glass substrate by a casting method to obtain a membrane having a thickness of 50 μm.

For the BP-2 cast membrane, the proton conductivity, the shape/size stability against water, and the mechanical strength of the membrane were evaluated in the same way as in Example 1. The results are summarized in Table 1.

### Comparative Example 2

The A-B type diblock copolymer BP-3 obtained in Synthesis Example 3 was dissolved a mixed solvent of THF/methanol so that a solid content concentration was 20% by weight. The resultant was then applied onto a glass substrate by a casting method to obtain a membrane having a thickness of 50 μm.

For the BP-3 cast membrane, the proton conductivity, the shape/size stability against water, and the mechanical strength of the membrane were evaluated in the same way as in Example 1. The results are summarized in Table 1.

The gas permeability in the BP-3 cast membrane was measured in the same way as in Example 1. As a result, the hydrogen permeability at 40° C. under a dry condition and that at 40° C. at a relative humidity of 90% were found to be 1.1×15 cm³/m²·24 h·atm in either case.

TABLE 1

| | Proton | Shape/size | Breaking | Breaking |
|---|---|---|---|---|
| | conductivity | stability | strength | extension |
| | (S/cm) | for water | (MPa) | (%) |
| Example 1 | 1.11 × 10⁻² | A | 18.1 | 17 |
| Example 2 | 8.64 × 10⁻³ | A | 19.2 | 15 |
| Example 3 | 1.22 × 10⁻² | A | 11.4 | 16 |
| Example 4 | 5.39 × 10⁻³ | A | 15.0 | 50 |
| Example 5 | 7.43 × 10⁻³ | A | 18.5 | 16 |
| Comparative | 7.91 × 10⁻³ | B | 4.03 | 1.6 |
| Example 1 | | | | |
| Comparative | 9.97 × 10⁻³ | C | 6.79 | 2.8 |
| Example 2 | | | | |

A membrane electrode assembly and a fuel cell unit were prepared through steps as shown below by way of example.

### Example 6

As a powdery catalyst, HiSPEC1000 (manufactured by Johnson & Massey Co.) was used. As an electrolyte solution, a solution of NafionO (manufactured by DuPont Co.) was used. Initially, the powdery catalyst and the electrolyte solution were mixed to form a mixture dispersion. The dispersion was formed into a film on a PTFE sheet by a doctor blade method, whereby a catalyst sheet was produced.

Next, the produced catalyst sheet was transferred, onto the obtained BP-1 electrolyte membrane prepared in Example 1, through hot pressing by a decal method at 100° C. and 100 kgf/cm² to form catalyst layers 22, 23 on an electrolyte membrane 21, whereby a membrane electrode assembly 20 (e.g., see FIG. 6) was produced. Further, the obtained membrane electrode assembly was arranged according to the numeral 20 illustrated in FIG. 7 to produce a fuel cell 30. At that time, a carbon cross electrode (manufactured by E-TEK) was used as a gas diffusion layer 33. An anode side separator 31, a current collector 32, a gasket 34, an anode side flow path 35, a cathode side flow path 36, and a cathode side separator 37 are shown in the example of FIG. 7.

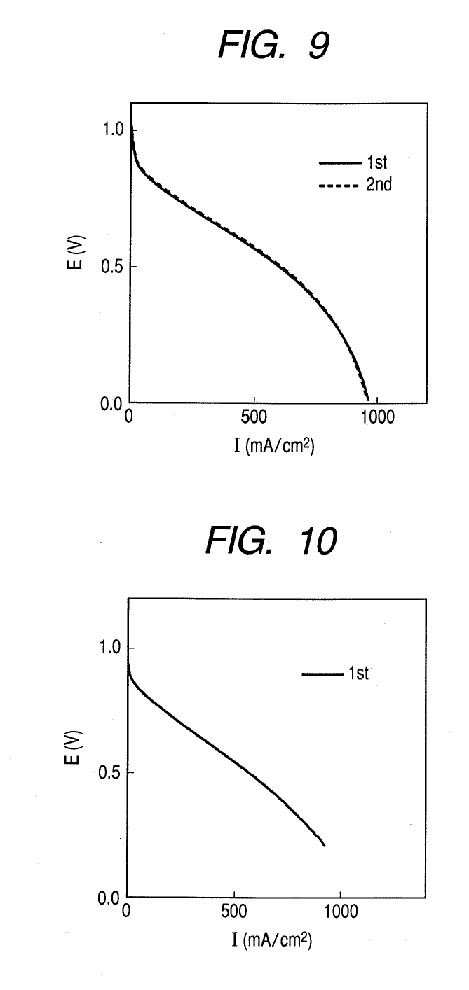

Using the produced fuel cell, hydrogen gas was supplied to the anode side at an injection rate of 500 mL/minute, an air was supplied to the cathode side at an injection rate of 2,000 mL/minute, a pressure at an outlet of the cell was an atmospheric pressure, the relative humidity both in the anode and the cathode was 100%, and the temperature in the cell was 25° C. An open circuit voltage in the obtained fuel cell was measured and was 1.02 V. Further, a current-voltage measurement was performed, and a cell potential at a current density of 400 mA/cm² was 680 mV (see, e.g., FIG. 9). Subsequently, the voltage was measured at constant current at current density of 400 mA/cm² for 5 hours, where no reduction of the cell voltage was observed and a stable output power was obtained. A power generation property after measuring at constant current for 5 hours is shown in FIG. 9. It was confirmed that there was no change in the power generation property before and after measuring at constant current.

### Comparative Example 3

A fuel cell was produced in the same condition as in Example 5, except that the BP-3 electrolyte membrane obtained in Comparative Example 2 was used, and was driven. The open circuit voltage of the obtained fuel cell was measured, and was 0.90 V. Further, the current-voltage measurement was performed, and the cell potential at current density of 400 mA/cm² was 600 mV (see FIG. 10). Subsequently, the measurement at constant current at current density of 200 mA/cm² was performed, but the cell voltage was rapidly reduced about 10 minutes after starting, and thus, the power generation was discontinued. After discontinuing the power generation, the membrane electrode assembly was observed, and membrane rupture was observed.

The polymer electrolyte membrane according to the examples of the present invention may be excellent in proton conductivity, evaluation of the shape/size stability against water, and mechanical strength of the membrane (e.g., tensile strength, toughness), by controlling the microphase separation structure in the electrolyte membrane using a triblock copolymer, and thus, the electrolyte membrane can be utilized as the electrolyte membrane for the fuel cells. The examples of the present invention also provide for a membrane electrode assembly and a fuel cell using the polymer electrolyte membrane.

According the examples of the present invention, there can be provided a polymer electrolyte membrane which is excellent in proton conductivity, evaluation of the shape/size stability against water, and mechanical strength of the membrane (e.g., tensile strength, toughness), and the polymer electrolyte which forms the polymer electrolyte membrane.

Embodiments of the present invention can also provide the membrane electrode assembly and the fuel cell using the aforementioned polymer electrolyte membrane.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-068441, filed Mar. 17, 2008, which is hereby incorporated by reference in its entirety.

What is claimed is:

1. A polymer electrolyte comprising a triblock copolymer including: a segment A which has a glass transition temperature of 40° C. or lower and is ion conductive; and a segment B which has a glass transition temperature of 70° C. or higher and is non-ion conductive, the segment A and the segment B being connected in a sequence of B-A-B, wherein a weight fraction W_{A} of the segment A in the triblock copolymer is 0.05<W_{A}<0.5.

2. The polymer electrolyte according to claim 1, wherein the triblock copolymer has at least one of an aliphatic hydrocarbon and an alicyclic hydrocarbon as a main chain.

3. A polymer electrolyte membrane comprising a microphase separation structure including an ion conductive domain and a non-ion conductive domain, wherein the microphase separation structure is formed of the polymer electrolyte according to claim 1.

4. The polymer electrolyte membrane according to claim 3, wherein the ion conductive domain forms a continuous phase and the non-ion conductive domain forms a matrix phase.

5. The polymer electrolyte membrane according to claim 3, wherein the ion conductive domain and the non-ion conductive domain form a lamellar structure.

6. A polymer electrolyte membrane comprising a triblock copolymer including: a segment A which has a glass transition temperature of 40° C. or lower and is ion conductive; and a segment B which has the glass transition temperature of 70° C. or higher and is non-ion conductive, the segment A and the segment B being connected in a sequence of B-A-B, wherein, in a microphase separation structure formed by the triblock copolymer, an ion conductive domain including the segment A forms a continuous phase and a non-ion conductive domain including the segment B forms a matrix phase.

7. The polymer electrolyte membrane according to claim 6, wherein the ion conductive domain including the segment A forms a cylindrical structure in the microphase separation structure.

8. The polymer electrolyte membrane according to claim 6, wherein the ion conductive domain including the segment A has a three-dimensional network structure in the microphase separation structure.

9. The polymer electrolyte membrane according to claim 6, wherein a weight fraction W_{A} of the segment A in the triblock copolymer is 0.05<W_{A}<0.5.

10. The polymer electrolyte membrane according to claim 6, wherein the triblock copolymer has at least one of an aliphatic hydrocarbon and an alicyclic hydrocarbon as a main chain.

11. A membrane electrode assembly, comprising electrodes placed on both sides of the polymer electrolyte membrane according to claim 3.

12. A fuel cell, comprising at least the membrane electrode assembly according to claim 11 and a current collector.

13. A membrane electrode assembly, comprising electrodes placed on both sides of the polymer electrolyte membrane according to claim 6.

14. A fuel cell, comprising at least the membrane electrode assembly according to claim 13 and a current collector.
